(19) United States
(12) Patent Application Publication
(10) Pub. No.: US 2026/0302246 A1
(43) Pub. Date: Oct. 1, 2026

(54) SECONDARY BATTERY AND ELECTRONIC DEVICE

(71) Applicant: Ningde Amperex Technology Limited, Ningde (CN)

(72) Inventors: Xiaoqian LIU, Ningde (CN); Dongdong HAN, Ningde (CN)

(73) Assignee: Ningde Amperex Technology Limited, Ningde (CN)

(21) Appl. No.: 19/575,964

(22) Filed: Mar. 24, 2026

(30) Foreign Application Priority Data
Mar. 31, 2025 (CN) 202510390404.4

(51) Int. Cl. H01M 4/62; H01M 4/02; H01M 4/131; H01M 4/36; H01M 10/0525

(52) U.S. Cl. CPC H01M 4/625; H01M 4/131; H01M 4/366; H01M 4/623; H01M 10/0525; H01M 2004/021; H01M 2004/028

(57) ABSTRACT

A secondary battery includes a positive electrode plate. The positive electrode plate includes a positive electrode current collector and a positive electrode material layer provided on at least one surface of the positive electrode current collector. The positive electrode material layer includes a positive electrode active material and a conductive agent. The conductive agent includes carbon black particles. A coverage rate of the carbon black particles on positive electrode active material particles is C %, and 60≤C≤98.

### CROSS-REFERENCE TO RELATED APPLICATION

This application claims priority to the Chinese Patent Application Serial No. 202510390404.4, filed on Mar. 31, 2025, the content of which is incorporated herein by reference in its entirety.

### TECHNICAL FIELD

This application relates to the field of electrochemical technology, and in particular to a secondary battery and an electronic device.

### BACKGROUND

Reducing internal resistance of lithium-ion batteries has always been a pursuit of customers. During cycling of lithium-ion batteries, positive electrode impedance dominates. Selecting new conductive agents and building a good conductive network are the main directions for reducing internal resistance of lithium-ion batteries.

In the prior art, internal resistance of a lithium-ion battery is generally reduced by increasing the content of a conductive agent or reducing the content of a binder. However, increasing the content of the conductive agent will lead to a reduction in the content of a positive electrode active material and a reduction in an energy density of the lithium-ion battery. Reducing the content of the binder will lead to a reduction in an adhesion force between a positive electrode material layer and a positive electrode current collector and a reduction in a cohesion of the positive electrode material layer itself, resulting in problems such as film fall-off and thickness swelling during the use of the lithium-ion battery.

### SUMMARY

The purpose of this application is to provide a secondary battery and an electronic device, so as to improve the dynamic performance of the secondary battery, offer the secondary battery with good high-temperature performance, and reduce the internal resistance of the secondary battery. The specific technical solutions are as follows:

A first aspect of this application provides a secondary battery, including a positive electrode plate, where the positive electrode plate includes a positive electrode current collector and a positive electrode material layer provided on at least one surface of the positive electrode current collector, the positive electrode material layer includes a positive electrode active material and a conductive agent, the conductive agent includes carbon black particles, and a coverage rate of the carbon black particles on positive electrode active material particles is C %, where 60≤C≤98. When the positive electrode material layer includes the positive electrode active material and the conductive agent, and the conductive agent includes the carbon black particles, after the carbon black particles are stacked, there are still certain gaps, which is more conducive to storing electrolyte. In addition, the carbon black particle units are small and evenly distributed on the surface of the positive electrode active material particles, which can cut the surface region of the positive electrode active material particles into smaller and more uniform parts, which is conducive to reducing the diffusion paths of Li⁺ and electrons, reducing Li⁺ concentration polarization, and improving the dynamic performance of the secondary battery. In addition, the carbon black particles are thinly applied on the surface of the positive electrode active material particles with an appropriate thickness, which is conducive to Li⁺ transmission and can also improve the dynamic performance of the secondary battery. The coverage rate of the carbon black particles on the positive electrode active material particles being within the range of this application reduces Li⁺ concentration polarization and improves the dynamic performance of the secondary battery, reduces the possibility of direct contact between the surface of the positive electrode active material and the electrolyte, offers the secondary battery further with good high-temperature performance, and can also reduce the internal resistance of the secondary battery.

In one embodiment of this application, 80≤C≤95. Regulating the coverage rate of the carbon black particles on the positive electrode active material particles within the above range reduces Li⁺ concentration polarization and further improves the dynamic performance of the secondary battery, reduces the possibility of direct contact between the surface of the positive electrode active material and the electrolyte, offers the secondary battery further with better high-temperature performance, and can further reduce the internal resistance of the secondary battery.

In one embodiment of this application, a stacking thickness of the carbon black particles on the surface of the positive electrode active material particles is H nm, where 20≤H≤60. By regulating the stacking thickness of the carbon black particles on the surface of the positive electrode active material particles within the above range, the stacking thickness of the carbon black particles on the surface of the positive electrode active material particles is moderate, which is conducive to Li⁺ transmission and can further improve the dynamic performance of the secondary battery.

In one embodiment of this application, an average particle size of primary particles of the carbon black particles is d1 nm, where 5≤d1≤40. In one embodiment of this application, the average particle size of the primary particles of the carbon black particles is d1 nm, where 10≤d1≤30. By regulating the average particle size of primary particles of the carbon black particles within the above range, the average particle size of primary particles of the carbon black particles is small, and the small-particle-size carbon black particles are thinly applied on the surface of the positive electrode active material with an appropriate thickness, which is conducive to Li⁺ transmission and can further improve the dynamic performance of the secondary battery.

In one embodiment of this application, a particle size Dᵥ50 of particles of the positive electrode material layer satisfies: 200d1≤Dᵥ50≤5000d1. The particle size Dᵥ50 of particles of the positive electrode material layer satisfying the above characteristics can make the carbon black particles fit more closely on the surface of the positive electrode active material, and can also make the positive electrode active material have appropriate gaps therebetween, allowing for tight filling of the positive electrode active material, and reducing the possibility of bridge breaking of the positive electrode active material. This is conducive to the construction of the conductive network and can further improve the dynamic performance of the secondary battery.

In one embodiment of this application, 3 μm≤Dᵥ50≤30 μm. By regulating the particle size Dᵥ50 of particles of the positive electrode material layer within the above range, the positive electrode active material can have good dynamic performance and the positive electrode active material can also have good high-temperature performance, so that the secondary battery has good dynamic performance and high-temperature performance.

In one embodiment of this application, the carbon black particles include element oxygen, and based on a mass of the carbon black particles, a mass percentage of the element oxygen is W_{O} %, where 0.3≤W_{O}≤3. The carbon black particles include the element oxygen, and regulating the mass percentage of the element oxygen within the above range can improve the self-dispersion of the carbon black particles, so that the carbon black particles are more evenly distributed on the surface of the positive electrode active material particles, which can further increase the distribution region of Li⁺, further reduce Li⁺ concentration polarization, and further improve the dynamic performance of the secondary battery.

In one embodiment of this application, the carbon black particles include element hydrogen, and based on a mass of the carbon black particles, a mass percentage of the element hydrogen is W_{H} %, where 0.1≤W_{H}≤0.5. The carbon black particles include the element hydrogen, and regulating the mass percentage of the element hydrogen within the above range can improve the self-dispersion of the carbon black particles, so that the carbon black particles are more evenly distributed on the surface of the positive electrode active material particles, which can further increase the distribution region of Li⁺, further reduce Li⁺ concentration polarization, and further improve the dynamic performance of the secondary battery.

In one embodiment of this application, the positive electrode material layer further includes an organic polymer, and a molecular weight distribution range of the organic polymer is 20000 to 2500000. The molecular weight distribution range of the organic polymer satisfying the above characteristics, first, can make the carbon black particles have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery; and second, can offer good adhesion between the substances in the positive electrode material layer and between the positive electrode material layer and the positive electrode current collector, which can reduce the electrode plate swelling and contact impedance growth during the cycling of the secondary battery and improve the cycling performance of the secondary battery.

In one embodiment of this application, a weight-average molecular weight of the organic polymer is Mw, where 300000≤Mw≤1500000. By regulating the weight-average molecular weight of the organic polymer within the above range, first, the carbon black particles can have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery; and second, can offer good adhesion between the substances in the positive electrode material layer and between the positive electrode material layer and the positive electrode current collector, which can reduce the electrode plate swelling and contact impedance growth during the cycling of the secondary battery and improve the cycling performance of the secondary battery.

In one embodiment of this application, a mass ratio of the conductive agent to the organic polymer is 0.5 to 1.0. By regulating the mass ratio of the conductive agent to the organic polymer within the above range, the conductive agent and the organic polymer have appropriate mass percentages, which is conducive to Li⁺ transmission and can further improve the dynamic performance of the secondary battery. This can also make the positive electrode material layer and the positive electrode current collector have good adhesion, can reduce the electrode plate swelling and contact impedance growth during the cycling of the secondary battery and improve the cycling performance of the secondary battery, and can improve the thermal stability of the positive electrode.

In one embodiment of this application, the organic polymer includes at least one of polyvinylidene fluoride, polyvinylpyrrolidone, hydrogenated nitrile rubber, a copolymer of vinylidene fluoride-hexafluoropropylene, polyacrylonitrile, polyacrylate, polyacrylic acid, polyacrylate salt, polyamide, polyvinyl ether, polymethyl methacrylate, polytetrafluoroethylene, polyhexafluoropropylene, styrene-butadiene rubber, polypropylene, polyethylene, polyetherimide, a copolymer of olefin derivatives, or carboxymethyl cellulose salt. Selecting the above organic polymer can make the carbon black particles have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery. This can also offer good adhesion between the substances in the positive electrode material layer and between the positive electrode material layer and the positive electrode current collector, and can reduce the electrode plate swelling and contact impedance growth during the cycling of the secondary battery and improve the cycling performance of the secondary battery.

In one embodiment of this application, based on a mass of the positive electrode material layer, a mass percentage of the positive electrode active material is W1%, a mass percentage of the conductive agent is W2%, and a mass percentage of the organic polymer is W3%, where 95.0≤W1≤99.0, 0.5≤W2≤2.0, and 0.5≤W3≤3.0. Regulating the mass percentages of the positive electrode active material, the conductive agent, and the organic polymer within the above ranges improves the dynamic performance of the secondary battery, offers the secondary battery further with good high-temperature performance, and can also reduce the internal resistance of the secondary battery.

In one embodiment of this application, the conductive agent further includes carbon nanotubes, and a diameter of the carbon nanotubes is d2 nm, where 3≤d2≤15. The conductive agent further includes the carbon nanotubes, and regulating the diameter of the carbon nanotubes within the above range offers the positive electrode slurry with good processing performance, can provide a high effective conductive area, and can further reduce the internal resistance of the secondary battery.

In one embodiment of this application, based on a mass of the positive electrode material layer, a mass percentage of the positive electrode active material is W1%, a mass percentage of the carbon black particles is W21%, a mass percentage of the carbon nanotubes is W22%, and a mass percentage of the organic polymer is W3%, where 95.0≤W1≤99.0, 0.3≤W21≤1.5, 0.2≤W22≤0.8, and 0.5≤W3≤3.0. Regulating the mass percentages of the positive electrode active material, the carbon black particles, the carbon nanotubes, and the organic polymer within the above ranges further improves the dynamic performance of the secondary battery, offers the secondary battery with better high-temperature performance, and can further reduce the internal resistance of the secondary battery.

In one embodiment of this application, an adhesion force between the positive electrode material layer and the positive electrode current collector is F N/m, where 5≤F≤25. By regulating the adhesion force between the positive electrode material layer and the positive electrode current collector within the above range, the positive electrode material layer and the positive electrode current collector have high adhesion force, which can reduce the electrode plate swelling and contact impedance growth during the cycling of the secondary battery and improve the cycling performance of the secondary battery.

In one embodiment of this application, the positive electrode active material includes at least one of lithium cobalt oxide, lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate. By selecting the above positive electrode active material, the secondary battery has good dynamic performance and good high-temperature performance, and the secondary battery also has low internal resistance.

A second aspect of this application provides an electronic device, including the secondary battery in any of the foregoing embodiments. Therefore, the electronic device provided by this application has good dynamic performance and high-temperature performance, and also has low internal resistance.

Beneficial Effects of this Application:

This application provides the secondary battery and the electronic device. The secondary battery includes the positive electrode plate. The positive electrode plate includes the positive electrode current collector and the positive electrode material layer provided on the at least one surface of the positive electrode current collector. The positive electrode material layer includes the positive electrode active material and the conductive agent. The conductive agent includes the carbon black particles. The coverage rate of the carbon black particles on the positive electrode active material particles is C %, where 60≤C≤98. By regulating the type of the conductive agent and the coverage rate of the carbon black particles on the positive electrode active material particles within the range of this application, the dynamic performance of the secondary battery is improved, the secondary battery also has good high-temperature performance, and the internal resistance of the secondary battery can also be reduced.

Certainly, any product or method implementing this application does not necessarily need to achieve all the advantages described above.

### DETAILED DESCRIPTION OF EMBODIMENTS

The technical solutions in this application will be clearly and completely described below in conjunction with the embodiments of this application. Obviously, the described embodiments are only a part of the embodiments of this application, rather than all the embodiments. All other embodiments obtained by those skilled in the art based on this application fall within the protection scope of this application.

It should be noted that in the specific embodiments of this application, lithium-ion batteries are used as examples of secondary batteries to explain this application, but the secondary battery of this application is not limited to lithium-ion batteries.

A first aspect of this application provides a secondary battery, including a positive electrode plate, where the positive electrode plate includes a positive electrode current collector and a positive electrode material layer provided on at least one surface of the positive electrode current collector, the positive electrode material layer includes a positive electrode active material and a conductive agent, the conductive agent includes carbon black particles, and a coverage rate of the carbon black particles on positive electrode active material particles is C %, where 60≤C≤98. Exemplarily, the value of C can be 60, 62, 64, 66, 68, 70, 72, 74, 76, 78, 80, 82, 84, 86, 88, 90, 92, 94, 96, 98 or a range defined by any two of the above values. In this application, the carbon black particles include at least one of Super P, acetylene black, or Ketjen black. The above “positive electrode material layer provided on at least one surface of the positive electrode current collector” means that the positive electrode material layer can be provided on one surface of the positive electrode current collector in the thickness direction thereof, or can be provided on two surfaces of the positive electrode current collector in the thickness direction thereof. It should be noted that the “surface” here can be the entire region of the positive electrode current collector or a part of the region of the positive electrode current collector, which is not particularly limited in this application as long as the purpose of this application can be achieved.

The inventors have found through research that when the positive electrode material layer includes the positive electrode active material and the conductive agent, and the conductive agent includes the carbon black particles, after the carbon black particles are stacked, there are still certain gaps, which is more conducive to storing electrolyte. In addition, the carbon black particle units are small and evenly distributed on the surface of the positive electrode active material particles, which can cut the surface region of the positive electrode active material particles into smaller and more uniform parts, which is conducive to reducing the diffusion paths of Li⁺ and electrons, reducing Li⁺ concentration polarization, and improving the dynamic performance of the secondary battery. In addition, the carbon black particles are thinly applied on the surface of the positive electrode active material particles with an appropriate thickness, which is conducive to Li⁺ transmission and can also improve the dynamic performance of the secondary battery. If the coverage rate of the carbon black particles on the positive electrode active material particles is too small, for example, less than 60%, there is too little conductive agent on the surface of the positive electrode active material, which increases the contact impedance of the positive electrode active material, reduces the distribution region of Li⁺ on the surface of the positive electrode active material, increases Li⁺ concentration polarization, and prolongs the movement path when Li⁺ combines with electrons on the surface of the positive electrode active material, resulting in poor dynamic performance of the secondary battery. If the coverage rate of the carbon black particles on the positive electrode active material particles is too large, for example, greater than 98%, there is too little exposed surface of the positive electrode active material, which also leads to poor dynamic performance of the secondary battery. The coverage rate of the carbon black particles on the positive electrode active material particles being within the range of this application reduces Li⁺ concentration polarization and improves the dynamic performance of the secondary battery, reduces the possibility of direct contact between the surface of the positive electrode active material and the electrolyte, offers the secondary battery with good high-temperature performance, and can also reduce the internal resistance of the secondary battery. In this application, high temperature means a temperature greater than or equal to 60° C.

In one embodiment of this application, 80≤C≤95. Exemplarily, the value of C can be 80, 82, 84, 86, 88, 90, 92, 94, 95 or a range defined by any two of the above values. Regulating the coverage rate of the carbon black particles on the positive electrode active material particles within the above range reduces Li⁺ concentration polarization and further improves the dynamic performance of the secondary battery, reduces the possibility of direct contact between the surface of the positive electrode active material and the electrolyte, offers the secondary battery with better high-temperature performance, and can further reduce the internal resistance of the secondary battery.

In one embodiment of this application, a stacking thickness of the carbon black particles on the surface of the positive electrode active material particles is H nm, where 20≤H≤60. Exemplarily, the value of H can be 20, 22, 24, 26, 28, 30, 32, 34, 36, 38, 40, 42, 44, 46, 48, 50, 52, 54, 56, 58, 60 or a range defined by any two of the above values. By regulating the stacking thickness of the carbon black particles on the surface of the positive electrode active material particles within the above range, the stacking thickness of the carbon black particles on the surface of the positive electrode active material particles is moderate, which is conducive to Li⁺ transmission and can further improve the dynamic performance of the secondary battery.

In one embodiment of this application, an average particle size of primary particles of the carbon black particles is d1 nm, where 5≤d1≤40. Exemplarily, the value of d1 can be 5, 7, 8, 10, 13, 15, 17, 20, 23, 25, 27, 30, 33, 35, 37, 40 or a range defined by any two of the above values. In one embodiment of this application, the average particle size of primary particles of the carbon black particles is d1 nm, where 10≤d1≤30. By regulating the average particle size of primary particles of the carbon black particles within the above range, the average particle size of primary particles of the carbon black particles is small, and the small-particle-size carbon black particles are thinly applied on the surface of the positive electrode active material with an appropriate thickness, which is conducive to Li⁺ transmission and can further improve the dynamic performance of the secondary battery.

In one embodiment of this application, the particle size Dᵥ50 of particles of the positive electrode material layer satisfies: 200d1≤Dᵥ50≤5000d1. The particle size Dᵥ50 of particles of the positive electrode material layer satisfying the above characteristics can make the carbon black particles fit more closely on the surface of the positive electrode active material, and can also make the positive electrode active material have appropriate gaps therebetween, allow the positive electrode active material to be filled more tightly, and reduce the possibility of bridge breaking between the positive electrode active material. This is conducive to the construction of the conductive network and can further improve the dynamic performance of the secondary battery.

In this application, Dᵥ50 refers to a particle size at which the volume accumulation reaches 50% from the small particle size in the volume-based particle size distribution of the material.

In one embodiment of this application, 3 μm≤Dᵥ50≤30 μm. Exemplarily, Dᵥ50 can be 3 μm, 5 μm, 7 μm, 9 μm, 10 μm, 13 μm, 15 μm, 17 μm, 19 μm, 20 μm, 23 μm, 25 μm, 27 μm, 29 μm, 30 μm or a range defined by any two of the above values. By regulating the particle size Dᵥ50 of particles of the positive electrode material layer within the above range, the positive electrode active material can have good dynamic performance and the positive electrode active material can have good high-temperature performance, so that the secondary battery has good dynamic performance and high-temperature performance.

In one embodiment of this application, the carbon black particles include element oxygen, and based on a mass of the carbon black particles, a mass percentage of the element oxygen is W_{O} %, where 0.3≤W_{O}≤3. Exemplarily, the value of W_{O} can be 0.3, 0.5, 0.7, 0.9, 1, 1.3, 1.5, 1.7, 1.9, 2, 2.3, 2.5, 2.7, 2.9, 3 or a range defined by any two of the above values. The carbon black particles include the element oxygen, and regulating the mass percentage of the element oxygen within the above range can improve the self-dispersion of the carbon black particles, so that the carbon black particles are more evenly distributed on the surface of the positive electrode active material particles, which can further increase the distribution region of Li⁺, further reduce Li⁺ concentration polarization, and further improve the dynamic performance of the secondary battery.

In one embodiment of this application, the carbon black particles include element hydrogen, and based on a mass of the carbon black particles, a mass percentage of the element hydrogen is W_{H} %, where 0.1≤W_{H}≤0.5. Exemplarily, the value of W_{H} can be 0.1, 0.15, 0.19, 0.2, 0.25, 0.29, 0.3, 0.35, 0.39, 0.4, 0.45, 0.49, 0.5 or a range defined by any two of the above values. The carbon black particles include the element hydrogen, and regulating the mass percentage of the element hydrogen within the above range can improve the self-dispersion of the carbon black particles, so that the carbon black particles are more evenly distributed on the surface of the positive electrode active material particles, which can further increase the distribution region of Li⁺, further reduce Li⁺ concentration polarization, and further improve the dynamic performance of the secondary battery.

In one embodiment of this application, the positive electrode material layer further includes an organic polymer, and a molecular weight distribution range of the organic polymer is 20000 to 2500000. Exemplarily, the molecular weight distribution range of the organic polymer can be 20000, 100000, 500000, 1000000, 1500000, 2000000, 2500000 or a range defined by any two of the above values. The above molecular weight distribution range refers to an overall distribution range of the molecular weight of the organic polymer. In this application, the organic polymer can be used as a binder in the positive electrode material layer. The binder is usually a high molecular polymer, which has both binding and dispersing effects. That is, it attaches to the surface of other materials, and these materials are dispersed through steric hindrance. Carbon black particles with high specific surface area are not prone to disperse, and more binder molecules need to attach to their surface to disperse them. Under the same content, a smaller molecular weight of the polymer means a larger number and better dispersing effect. However, binding requires a polymer with higher molecular weight. Therefore, polymers with both a small molecular weight and a large molecular weight are selected as the binder. When the molecular weight distribution range of the organic polymer satisfies the above characteristics, the molecular weight distribution range of the organic polymer is wide, including a small molecular weight and a large molecular weight. The organic polymer with a small molecular weight and large molecular weight being applied to the positive electrode material layer, first, can make the carbon black particles have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery; and second, can offer good adhesion between the substances in the positive electrode material layer and between the positive electrode material layer and the positive electrode current collector, which can reduce the electrode plate swelling and contact impedance growth during the cycling of the secondary battery and improve the cycling performance of the secondary battery. In this application, the organic polymer with a small molecular weight can refer to an organic polymer with a molecular weight distribution range of 20000 to 250000. The organic polymer with a large molecular weight can refer to an organic polymer with a molecular weight distribution range of 250000 to 2500000.

In one embodiment of this application, a weight-average molecular weight of the organic polymer is Mw, where 300000≤Mw≤1500000. Exemplarily, the value of Mw can be 300000, 400000, 500000, 600000, 700000, 800000, 900000, 1000000, 1100000, 1200000, 1300000, 1400000, 1500000 or a range defined by any two of the above values. The above weight-average molecular weight refers to a statistical average molecular weight by mass. The molecular weight distribution range of the organic polymer affects the weight-average molecular weight of the organic polymer. By regulating the weight-average molecular weight of the organic polymer within the above range, the molecular weight of the organic polymer includes both a small molecular weight and a large molecular weight. The organic polymer with a small molecular weight and a large molecular weight being applied to the positive electrode material layer, first, can make the carbon black particles have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery; and second, can offer good adhesion between the substances in the positive electrode material layer and between the positive electrode material layer and the positive electrode current collector, which can reduce the electrode plate swelling and contact impedance growth during the cycling of the secondary battery and improve the cycling performance of the secondary battery.

In one embodiment of this application, a mass ratio of the conductive agent to the organic polymer is 0.5 to 1.0. Exemplarily, the mass ratio of the conductive agent to the organic polymer can be 0.5, 0.55, 0.6, 0.65, 0.7, 0.75, 0.8, 0.85, 0.9, 0.95, 1.0 or a range defined by any two of the above values. By regulating the mass ratio of the conductive agent to the organic polymer within the above range, the conductive agent and the organic polymer have appropriate mass percentages, which is conducive to Li⁺ transmission and can further improve the dynamic performance of the secondary battery; and the positive electrode material layer and the positive electrode current collector can have good adhesion, which can reduce the electrode plate swelling and contact impedance growth during the cycling of the secondary battery, improve the cycling performance of the secondary battery; and can improve the thermal stability of the positive electrode.

In one embodiment of this application, the organic polymer includes at least one of polyvinylidene fluoride (PVDF), polyvinylpyrrolidone (PVP), hydrogenated nitrile rubber (HNBR), a copolymer of vinylidene fluoride-hexafluoropropylene, polyacrylonitrile, polyacrylate, polyacrylic acid, polyacrylate salt, polyamide, polyvinyl ether, polymethyl methacrylate, polytetrafluoroethylene, polyhexafluoropropylene, styrene-butadiene rubber, polypropylene, polyethylene, polyetherimide, a copolymer of olefin derivatives, or carboxymethyl cellulose salt. The above carboxymethyl cellulose salt can include but is not limited to at least one of sodium carboxymethyl cellulose, potassium carboxymethyl cellulose, or lithium carboxymethyl cellulose. With the above organic polymer selected, the above organic polymer has good dispersing and binding effects, and can make the carbon black particles have good dispersion, so that the carbon black particles are more evenly distributed on the surface of the positive electrode active material particles, which can further increase the distribution region of Li⁺, further reduce Li⁺ concentration polarization, and further improve the dynamic performance of the secondary battery; can also can offer good adhesion between the substances in the positive electrode material layer and between the positive electrode material layer and the positive electrode current collector, which can reduce the electrode plate swelling and contact impedance growth during the cycling of the secondary battery and improve the cycling performance of the secondary battery.

In one embodiment of this application, based on a mass of the positive electrode material layer, a mass percentage of the positive electrode active material is W1%, a mass percentage of the conductive agent is W2%, and a mass percentage of the organic polymer is W3%, where 95.0≤W1≤99.0, 0.5≤W2≤2.0, and 0.5≤W3≤3.0. Exemplarily, the value of W1 can be 95.0, 95.5, 95.9, 96.0, 96.5, 96.9, 97.0, 97.5, 97.9, 98.0, 98.5, 98.9, 99.0 or a range defined by any two of the above values. The value of W2 can be 0.5, 0.7, 0.9, 1.0, 1.1, 1.3, 1.5, 1.7, 1.9, 2.0 or a range defined by any two of the above values. The value of W3 can be 0.5, 0.7, 0.9, 1.0, 1.5, 1.7, 1.9, 2.0, 2.5, 2.7, 2.9, 3.0 or a range defined by any two of the above values. Regulating the mass percentages of the positive electrode active material, the conductive agent, and the organic polymer within the above ranges improves the dynamic performance of the secondary battery, offers the secondary battery with good high-temperature performance, and can also reduce the internal resistance of the secondary battery.

In one embodiment of this application, the conductive agent further includes carbon nanotubes, and a diameter of the carbon nanotubes is d2 nm, where 3≤d2≤15. Exemplarily, the value of d2 can be 3, 4, 5, 6, 7, 8, 9, 10, 11, 12, 13, 14, 15 or a range defined by any two of the above values. The above carbon nanotubes include single-walled carbon nanotubes and/or multi-walled carbon nanotubes. The conductive agent further includes carbon nanotubes, and regulating the diameter of the carbon nanotubes within the above range makes the positive electrode slurry have good processing performance, can provide a high effective conductive area, and can further reduce the internal resistance of the secondary battery.

In one embodiment of this application, based on a mass of the positive electrode material layer, a mass percentage of the positive electrode active material is W1%, a mass percentage of the carbon black particles is W21%, a mass percentage of the carbon nanotubes is W22%, and a mass percentage of the organic polymer is W3%, where 95.0≤W1≤99.0, 0.3≤W21≤1.5, 0.2≤W22≤0.8, and 0.5≤W3≤3.0. Exemplarily, the value of W1 can be 95.0, 95.5, 95.9, 96.0, 96.5, 96.9, 97.0, 97.5, 97.9, 98.0, 98.5, 98.9, 99.0 or a range defined by any two of the above values. The value of W21 can be 0.3, 0.5, 0.7, 0.9, 1.0, 1.1, 1.3, 1.5 or a range defined by any two of the above values. The value of W22 can be 0.2, 0.3, 0.4, 0.5, 0.6, 0.7, 0.8 or a range defined by any two of the above values. The value of W3 can be 0.5, 0.7, 0.9, 1.0, 1.5, 1.7, 1.9, 2.0, 2.5, 2.7, 2.9, 3.0 or a range defined by any two of the above values. Regulating the mass percentages of the positive electrode active material, the carbon black particles, the carbon nanotubes, and the organic polymer within the above ranges further improves the dynamic performance of the secondary battery, offers the secondary battery with better high-temperature performance, and can further reduce the internal resistance of the secondary battery.

In one embodiment of this application, an adhesion force between the positive electrode material layer and the positive electrode current collector is F N/m, where 5≤F≤25. Exemplarily, the value of F can be 5, 7, 9, 10, 11, 13, 15, 17, 19, 20, 21, 23, 25 or a range defined by any two of the above values. By regulating the adhesion force between the positive electrode material layer and the positive electrode current collector within the above range, the positive electrode material layer and the positive electrode current collector have high adhesion force, which can reduce the electrode plate swelling and contact impedance growth during the cycling of the secondary battery and improve the cycling performance of the secondary battery.

In one embodiment of this application, the positive electrode active material includes at least one of lithium cobalt oxide (LiCoO₂), lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate. The above lithium nickel cobalt manganate can include at least one of LiNi_{0.95}Co_{0.03}Mn_{0.02}O₂(Ni95), LiNi_{0.91}Co_{0.03}Mn_{0.06}O₂(Ni91), LiNi_{0.8}Co_{0.1}Mn_{0.1}O₂ (NCM811), LiNi_{0.6}Co_{0.2}Mn_{0.2}O₂ (NCM622), LiNi_{0.5}Co_{0.2}Mn_{0.3}O₂(NCM523), or LiNi_{1/3}Co_{1/3}Mn_{1/3}O₂ (NCM111). With the above positive electrode active material selected, the secondary battery has good dynamic performance and good high-temperature performance, and the secondary battery also has low internal resistance.

In one embodiment of this application, under a capacity of 3000 mAh to 6000 mAh, the secondary battery has a is direct current impedance (DCR) of 20 mΩ to 60 mΩ at 25° C. and 20% state of charge (SOC), and an internal resistance growth rate R1 of 10% to 40% after 800 cycles at 25° C. The direct current impedance and the internal resistance growth rate after 800 cycles of the secondary battery being within the above ranges indicates that the secondary battery has good dynamic performance and the secondary battery has low internal resistance.

This application has no particular limitation on the preparation method of the carbon black particles, as long as the purpose of this application can be achieved. For example, the preparation method of the carbon black particles can include the following steps: selecting acetylene or tar as a raw material; subjecting the raw material to a high-temperature pyrolysis reaction, where the high-temperature pyrolysis reaction features a temperature of 1000° C. to 1500° C., and time of the high-temperature pyrolysis reaction is 0.1 s to 3 s, to obtain the carbon black particles; and blowing the above carbon black particles out of a furnace tube, and performing cooling and collecting to obtain the desired carbon black particles. The above preparation method can introduce —COOH, —OH, —CO on the surface of the carbon black particles, which can improve the self-dispersion of the carbon black particles.

This application has no particular limitation on the way to regulate the coverage rate of the carbon black particles on the positive electrode active material particles, as long as the purpose of this application can be achieved. For example, the coverage rate of the carbon black particles on the positive electrode active material particles can be regulated by regulating the mass percentage of the element oxygen, the mass percentage of the element hydrogen in the carbon black particles, or the mass percentage of the carbon black particles in the positive electrode material layer.

This application has no particular limitation on the way to regulate the stacking thickness of the carbon black particles on the surface of the positive electrode active material particles, as long as the purpose of this application can be achieved. For example, the stacking thickness of the carbon black particles on the surface of the positive electrode active material particles can be regulated by regulating the mass percentage of the carbon black particles.

This application has no particular limitation on the way to regulate the average particle size of primary particles of the carbon black particles, as long as the purpose of this application can be achieved. For example, the average particle size of primary particles of the carbon black particles can be regulated by regulating the reaction time of the high-temperature pyrolysis reaction. For example, commercially available carbon black particles with different average particle sizes of primary particles can be selected.

This application has no particular limitation on the way to regulate the particle size Dᵥ50 of particles of the positive electrode material layer, as long as the purpose of this application can be achieved. For example, the particle size Dᵥ50 of particles of the positive electrode material layer can be regulated by regulating the particle size Dᵥ50 of the positive electrode active material and/or the conductive agent.

This application has no particular limitation on the way to regulate the mass percentage of the element oxygen, as long as the purpose of this application can be achieved. For example, the mass percentage of the element oxygen can be regulated by regulating the content of element oxygen in the synthesis gas introduced during the high-temperature pyrolysis reaction.

This application has no particular limitation on the way to regulate the mass percentage of the element hydrogen, as long as the purpose of this application can be achieved. For example, the mass percentage of the element hydrogen can be regulated by regulating the content of element hydrogen in the synthesis gas introduced during the high-temperature pyrolysis reaction.

This application has no particular limitation on the way to regulate the mass ratio of the conductive agent to the organic polymer, as long as the purpose of this application can be achieved. For example, the mass ratio of the conductive agent to the organic polymer can be regulated by regulating the mass of the added conductive agent and/or organic polymer. Exemplarily, when other conditions are unchanged, increasing the addition amount of the conductive agent increases the mass ratio of the conductive agent to the organic polymer; and reducing the addition amount of the conductive agent decreases the mass ratio of the conductive agent to the organic polymer. Exemplarily, when other conditions are unchanged, reducing the addition amount of the organic polymer increases the mass ratio of the conductive agent to the organic polymer; and increasing the addition amount of the organic polymer decreases the mass ratio of the conductive agent to the organic polymer.

This application has no particular limitation on the way to regulate the mass percentages of the positive electrode active material, the conductive agent, and the organic polymer, as long as the purpose of this application can be achieved. For example, the mass percentage of the positive electrode active material can be regulated by regulating the mass of the added positive electrode active material; the mass percentage of the conductive agent can be regulated by regulating the mass of the added conductive agent; and the mass percentage of the organic polymer can be regulated by regulating the mass of the added organic polymer.

This application has no particular limitation on the way to regulate the diameter of the carbon nanotubes, as long as the purpose of this application can be achieved. For example, the diameter of the carbon nanotubes can be regulated by regulating the synthesis temperature of the carbon nanotubes. For example, commercially available carbon nanotubes with different diameters can be selected.

This application has no particular limitation on the way to regulate the adhesion force between the positive electrode material layer and the positive electrode current collector, as long as the purpose of this application can be achieved. For example, the adhesion force between the positive electrode material layer and the positive electrode current collector can be regulated by regulating the mass percentage of the organic polymer in the positive electrode material layer.

This application has no particular limitation on the positive electrode current collector, as long as the purpose of this application can be achieved. For example, it can include aluminum foil, aluminum alloy foil, composite current collector (such as aluminum-carbon composite current collector), or the like.

This application has no particular limitation on the thickness of the positive electrode current collector, as long as the purpose of this application can be achieved. For example, the thickness of the positive electrode current collector is 6 μm to 16 μm. This application has no particular limitation on the thickness of the positive electrode material layer, as long as the purpose of this application can be achieved. For example, the thickness of the positive electrode material layer on one surface is 25 μm to 250 μm.

Optionally, the positive electrode plate can further include a conductive layer, and the conductive layer is located between the positive electrode current collector and the positive electrode material layer. This application has no particular limitation on the composition of the conductive layer, which can be a conductive layer commonly used in the art. The conductive layer includes a conductive agent and a binder. This application has no particular limitation on the conductive agent and the binder in the conductive layer, which can be at least one of the above conductive agent and the above organic polymer. This application has no particular limitation on the mass ratio of the conductive agent and the binder in the conductive layer, which can be selected by those skilled in the art according to actual needs, as long as the purpose of this application can be achieved.

In this application, the secondary battery further includes a negative electrode plate. The negative electrode plate includes a negative electrode current collector and a negative electrode material layer provided on at least one surface of the negative electrode current collector. The above “negative electrode material layer provided on at least one surface of the negative electrode current collector” means that the negative electrode material layer can be provided on one surface of the negative electrode current collector in the thickness direction thereof, or can be provided on two surfaces of the negative electrode current collector in the thickness direction thereof. It should be noted that the “surface” here can be the entire region of the negative electrode current collector or a part of the region of the negative electrode current collector, which is not particularly limited in this application as long as the purpose of this application can be achieved. This application has no particular limitation on the negative electrode current collector, as long as the purpose of this application can be achieved. For example, it can include copper foil, copper alloy foil, nickel foil, stainless steel foil, titanium foil, foamed nickel, foamed copper, composite current collector, or the like.

The negative electrode material layer of this application includes a negative electrode active material. This application has no particular limitation on the negative electrode active material, as long as the purpose of this application can be achieved. For example, the negative electrode active material can include at least one of natural graphite, artificial graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structured lithium titanate Li₄Ti₅O₁₂, Li—Al alloy, or metallic lithium. The negative electrode material layer of this application further includes a negative electrode binder and a negative electrode conductive agent. This application has no particular limitation on the negative electrode binder and the negative electrode conductive agent in the negative electrode material layer, as long as the purpose of this application can be achieved. For example, the negative electrode binder can be at least one of the above organic polymer, and the negative electrode conductive agent can be at least one of the above conductive agent. This application has no particular limitation on the mass ratio of the negative electrode active material, the negative electrode binder, and the negative electrode conductive agent in the negative electrode material layer, which can be selected by those skilled in the art according to actual needs, as long as the purpose of this application can be achieved.

This application has no particular limitation on the thickness of the negative electrode current collector, as long as the purpose of this application can be achieved. For example, the thickness of the negative electrode current collector is 4 μm to 12 μm. This application has no particular limitation on the thickness of the negative electrode material layer, as long as the purpose of this application can be achieved. For example, the thickness of the negative electrode material layer on one surface is 30 μm to 250 μm.

Optionally, the negative electrode plate can further include a conductive layer, and the conductive layer is located between the negative electrode current collector and the negative electrode material layer. This application has no particular limitation on the composition of the conductive layer, which can be a conductive layer commonly used in the art. The conductive layer includes a conductive agent and a binder. This application has no particular limitation on the conductive agent and the binder in the conductive layer, which can be at least one of the above negative electrode conductive agent and the above negative electrode binder. This application has no particular limitation on the mass ratio of the conductive agent and the binder in the conductive layer, which can be selected by those skilled in the art according to actual needs, as long as the purpose of this application can be achieved.

In this application, the secondary battery further includes an electrolyte. The electrolyte includes a lithium salt and a non-aqueous solvent. The lithium salt can include various lithium salts commonly used in the art, such as at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalate)borate (LiBOB), or lithium difluoroborate. This application has no particular limitation on the non-aqueous solvent, as long as the purpose of this application can be achieved. For example, it can include but is not limited to at least one of carbonate compound, carboxylate compound, ether compound, or other organic solvents. The above carbonate compound can include but is not limited to at least one of chain carbonate compound, cyclic carbonate compound, or fluorinated carbonate compound. The above chain carbonate compound can include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (EMC). The above cyclic carbonate compound can include but is not limited to at least one of ethylene carbonate (EC), propylene carbonate (PC), butylene carbonate (BC), or vinylethylene carbonate (VEC). The above fluorinated carbonate compound can include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The above carboxylate compound can include but is not limited to at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The above ether compound can include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents can include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. This application has no particular limitation on the mass percentages of the lithium salt and the non-aqueous solvent, as long as the purpose of this application can be achieved.

In this application, the secondary battery further includes a separator. The separator is used to separate the positive electrode plate and the negative electrode plate, prevent internal short circuit of the secondary battery, allow electrolyte ions to pass freely, and does not affect the electrochemical charge and discharge process. This application has no particular limitation on the separator, as long as the purpose of this application can be achieved. For example, the material of the separator can include but is not limited to at least one of polyethylene (PE), polypropylene (PP)-based polyolefin (PO), polyester (such as polyethylene terephthalate (PET) film), cellulose, polyimide (PI), polyamide (PA), spandex, or aramid; the type of the separator can include at least one of woven film, non-woven film, microporous film, composite film, calendered film, or spun film.

In this application, the separator can include a base film and a surface treatment layer. The base film can be a non-woven fabric or composite film with a porous structure, and the material of the base film can include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film can be used. Optionally, the surface treatment layer is provided on at least one surface of the base film, and the surface treatment layer can be a polymer layer or an inorganic substance layer, or a layer formed by mixing polymer and inorganic substance. For example, the inorganic substance layer includes inorganic particles and a binder for separator. This application has no particular limitation on the above inorganic particles, which for example can include at least one of alumina, silica, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. This application has no particular limitation on the above binder for separator, which for example can be at least one of the foregoing negative electrode binder. The polymer layer includes a first polymer, and the material of the first polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

The secondary battery of this application further includes a packaging bag for accommodating the positive electrode plate, the separator, the negative electrode plate, and the electrolyte, as well as other components known in the art in the secondary battery. This application does not limit the above other components. This application has no particular limitation on the packaging bag, which can be a packaging bag known in the art, as long as the purpose of this application can be achieved.

This application has no particular limitation on the type of the secondary battery, which can include any device that undergoes an electrochemical reaction. In this application, the secondary battery can include but is not limited to: lithium metal secondary battery, lithium-ion secondary battery (lithium-ion battery), lithium polymer secondary battery, lithium-ion polymer secondary battery, or the like.

The preparation process of the secondary battery of this application is well known to those skilled in the art, and this application has no particular limitation. For example, it can include but is not limited to the following steps: stacking the positive electrode plate, the separator, and the negative electrode plate in order, performing winding or folding as needed to obtain an electrode assembly with a wound structure, placing the electrode assembly in a packaging bag, and injecting the electrolyte into the packaging bag and performing sealing to obtain a secondary battery; or laminating the positive electrode plate, the separator, and the negative electrode plate in order, fixing the four corners of the entire laminated structure with tape to obtain an electrode assembly with a laminated structure, placing the electrode assembly in a packaging bag, and injecting the electrolyte into the packaging bag and performing sealing to obtain a secondary battery. In addition, an overcurrent prevention element, a guide plate, or the like can be placed in the packaging bag as needed to prevent pressure rise, overcharge, and overdischarge inside the secondary battery. The packaging bag is a packaging bag known in the art, and this application does not limit it.

A second aspect of this application provides an electronic device, including the secondary battery in any of the foregoing embodiments. Therefore, the electronic device provided by this application has good dynamic performance and high-temperature performance, and also has low internal resistance.

This application has no particular limitation on the type of the electronic device, which can be any electronic device known in the prior art. In some embodiments, the electronic device can include but is not limited to: notebook computer, pen input computer, mobile computer, e-book player, portable telephone, portable fax machine, portable copier, portable printer, stereo headset, video recorder, LCD TV, portable cleaner, portable CD player, mini disc, transceiver, electronic notebook, calculator, memory card, portable recorder, radio, backup power supply, motor, automobile, motorcycle, electric bicycle, bicycle, lighting fixture, toy, game console, clock, power tool, flash lamp, camera, large household battery, lithium ion capacitor, or the like.

### EXAMPLES

Hereinafter, examples and comparative examples are given to explain the embodiments of this application more specifically. Various tests and evaluations are performed according to the following methods. In addition, unless otherwise specified, “parts” and “%” are on a mass basis.

### Test Methods and Equipment:

### Test for Coverage Rate of Carbon Black Particles on Positive Electrode Active Material Particles:

(1) A lithium-ion battery was disassembled to obtain a positive electrode plate. (2) The above positive electrode plate was soaked in dimethyl carbonate (DMC) at room temperature for 30 min, taken out, and then dried. (3) The positive electrode plate obtained in step (2) was taken, a cross section of a positive electrode material layer on the positive electrode plate was obtained by liquid nitrogen brittle fracture, and the surface of positive electrode active material particles in the above cross section was observed under a scanning electron microscope (SEM, model: Thermo Fisher FEI-Apreo S) at 10000 magnifications. The coverage area of carbon black particles was S1, and the non-coverage area of the carbon black particles was S2. Coverage rate C (%) of the carbon black particles on the positive electrode active material particles=S1/(S1+S2)×100%, where the sum of S1+S2 was at least 2 mm².

### Test for Stacking Thickness of Carbon Black Particles on Surface of Positive Electrode Active Material Particles:

(1) Under the condition of 25±2° C., a lithium-ion battery was discharged at 0.5 C constant current to 3.0 V, left standing for 5 min, and then disassembled to obtain a positive electrode plate. (2) The above positive electrode plate was soaked in DMC at 65±5° C. for 30 min, taken out, and then dried. (3) The positive electrode plate obtained in step (2) was taken, a cross section of a positive electrode material layer on the positive electrode plate was obtained by plasma cutting, and a stacking thickness of carbon black particles on the surface of positive electrode active material particles was observed and tested by SEM at 10000 magnifications. Tests were conducted at 40 different positions, and the average value of all test values was taken as the final result.

### Test for Average Particle Size of Primary Particles of Carbon Black Particles:

(1) A lithium-ion battery was disassembled to obtain a positive electrode plate; (2) The above positive electrode plate was soaked in DMC at room temperature for 30 min, taken out, and then dried. (3) The positive electrode plate obtained in step (2) was corroded with concentrated sulfuric acid, filtered to obtain a conductive agent, and dried, and an average particle size of primary particles of carbon black particles was tested under a transmission electron microscope (TEM) at 80000 magnifications. The average particle sizes of primary particles of 50 carbon black particles were tested, and the average of all test values was taken as the final result.

### Test of Particle Size Dᵥ50 of Particles of Positive Electrode Material Layer:

(1) A lithium-ion battery was disassembled to obtain a positive electrode plate. (2) The above positive electrode plate was soaked in N-methylpyrrolidone (NMP) at 45±5° C. until a positive electrode material layer film peeled off from a positive electrode current collector, then the positive electrode current collector was removed, and the positive electrode material layer film was dissolved in NMP and uniformly dispersed with a disperser to obtain a positive electrode material layer slurry. (3) The above positive electrode material layer slurry was tested with a Malvern particle size tester (model: MasterSizer 2000) to obtain a particle size Dᵥ50 of particles of the positive electrode material layer.

### Test for Mass Percentage of Elements:

A German Elementar elemental analyzer was used to test the types of elements in the carbon black particles and the mass percentages of the elements in the carbon black particles.

### Test for Weight-Average Molecular Weight and Molecular Weight Distribution Range:

(1) A lithium-ion battery was disassembled to obtain a positive electrode plate. (2) The above positive electrode plate was soaked in a solvent NMP to remove a film, so that a positive electrode material layer film was dissolved in the solvent, and uniformly dispersed with a disperser to obtain a slurry. (3) The above slurry was taken, a binder in the slurry was separated by centrifugation, and a weight-average molecular weight and a molecular weight distribution range of the binder were determined by gel permeation chromatography (GPC) using a gel chromatograph with a model of PL-GPC220.

### Test of Diameter of Carbon Nanotubes:

(1) A lithium-ion battery was disassembled to obtain a positive electrode plate. (2) The above positive electrode plate was soaked in DMC at room temperature for 60 min, taken out, and dried at room temperature. (3) The positive electrode plate obtained in step (2) was used, a cross section of a positive electrode material layer on the positive electrode plate was obtained by liquid nitrogen brittle fracture. (4) The above cross section was observed by SEM, diameters of no less than 30 carbon nanotubes in total was tested in 10 regions, and the average value was taken as a diameter of the carbon nanotubes.

### Adhesion Force Test:

(1) A lithium-ion battery was disassembled to obtain a positive electrode plate. (2) The above positive electrode plate was soaked in DMC at 25±5° C. for 30 min, and then dried. (3) The positive electrode plate obtained in step (2) was used, and an adhesion force between a positive electrode material layer and a positive electrode current collector was tested by a Gotech tensile machine (model GT-7010-EP) with the 900 angle method. Specifically, the part of the positive electrode plate coated with the positive electrode material layer was cut into a strip (with a size of 80 mm×20 mm), and a part of the positive electrode plate along a length direction was adhered to a steel plate through double-sided tape from one end of the positive electrode plate. Then, the steel plate was fixed at a corresponding position of a Gotech tensile machine, the positive electrode plate not adhered to the steel plate was pulled up, and the positive electrode plate was directly clamped into a chuck. When a clamp mouth tension was greater than 0 kgf and less than 0.02 kgf, the test was started with the Gotech tensile machine at a speed of 5 mm/min, and an average value of the tension in a stable region finally measured was recorded as an adhesion force between the positive electrode material layer and the positive electrode current collector. A ratio of a standard deviation of adhesion force data in this stable region to the average value was required not to exceed 10%.

### 1 s Direct Current Impedance (DCR) Test:

A lithium-ion battery from the example or comparative example was taken and the following test was performed at 25±2° C.: (1) it was left standing for 2 h; (2) it was then charged at a constant current of 1.0 C to 4.50 V, charged at a constant voltage of 4.50 V until the current was less than or equal to 0.025 C, and then left standing for 2 h; (3) it was then discharged at a constant current of 0.2 C to 3.0 V, with a discharge capacity of this step recorded as C1; and then left standing for 5 h; (4) it was then charged at a constant current of 1.0 C1 to 4.50 V, charged at a constant voltage of 4.50 V until the current was less than or equal to 0.025 C1, and then left standing for 10 min; and (5) it was then discharged at a constant current of 0.1 C1 until a capacity of 0.2 C1 was reached, left standing for 15 min, with the voltage at this time recorded as V₀; and then discharged at a constant current of 1.0 C1 for 1 s, with the voltage at this time recorded as V₁. 1 s DCR at 25° C. and 20% SOC was (V₀−V₁)/1.0 C1.

Test for Internal Resistance Growth Rate after 800 Cycles at 25° C.:

The lithium-ion battery in the example or comparative example was taken, and the following test was performed at 25±2° C.:

(1) It was left standing for 2 h, discharged at a constant current of 0.7 C to 3.0 V, and then left standing for 5 min.

(2) It was charged at a constant current of 1.0 C to 4.50 V, followed by constant voltage charging at 4.50 V until a current was less than or equal to 0.05 C; left standing for 5 min; discharged at a constant current of 0.5 C to 3.0 V, where an internal resistance of the lithium-ion battery at this time was tested with 1000 Hz sinusoidal current and recorded as IMP1; and left standing for 5 min. The above steps were repeated 49 times, and the internal resistance of the lithium-ion battery was recorded as IMP1, IMP2, . . . , IMP49 in sequence. The 50th cycle was then performed. In the 50th cycle, it was charged at a constant current of 1.0 C to 4.50 V, followed by constant voltage charging at 4.50 V until the current was less than or equal to 0.05 C; left standing for 5 min; and then discharged at a constant current of 0.2 C to 3.0 V The internal resistance of the lithium-ion battery at this time was recorded as IMP50.

(3) It was subjected to the above step (2) for 16 times; then charged at a constant current of 1.0 C to 4.50 V, followed by constant voltage charging at 4.50 V until the current was less than or equal to 0.05 C; left standing for 5 min; and then discharged at a constant current of 0.5 C to 3.0 V An internal resistance of the lithium-ion battery in the 801st cycle was recorded as IMP801. Internal resistance growth rate R1(%) of lithium-ion battery after 800 cycles at 25° C.=IMP801/IMP1-100%.

### High-Temperature Performance Test:

In an environment of 25±3° C., the lithium-ion battery was charged at a constant current of 0.5 C to 4.50 V, followed by constant voltage charging at 4.50 V until the current was less than or equal to 0.025 C. The initial thickness of the lithium-ion battery was tested and recorded as T1. The lithium-ion battery was then placed in a high-temperature furnace at 85±3° C. for storage for 8 h. The thickness of the lithium-ion battery was then tested in situ and recorded as T2. High-temperature storage thickness swelling rate T (%) of lithium-ion battery=(T2−T1)/T1×100%.

In this application, the high-temperature storage thickness swelling rate of the lithium-ion battery is used to indicate the high-temperature performance of the lithium-ion battery. A smaller high-temperature storage thickness swelling rate of the lithium-ion battery indicates better high-temperature performance of the lithium-ion battery.

### Example 1-1

### <Preparation of Positive Electrode Plate>

Lithium cobalt oxide (LiCoO₂) as a positive electrode active material, carbon black particles as a conductive agent, carbon nanotubes as a conductive agent, and polyvinylidene fluoride (PVDF) as an organic polymer were mixed in a weight ratio of 97.6:0.4:0.5:1.5; and NMP was added as a solvent. These substances were stirred and mixed to uniformity to obtain a positive electrode slurry, where a solid content of the positive electrode slurry was 70 wt %. A particle size Dᵥ50 of the positive electrode active material was 17 μm. The carbon black particles were acetylene black, and the carbon nanotubes were multi-walled carbon nanotubes. The positive electrode slurry was uniformly applied on one surface of a 12 μm-thick aluminum foil serving as a positive electrode current collector, and dried at 120° C. for 1 h to obtain a positive electrode plate with a positive electrode material layer of 100 μm in thickness applied on one surface. The above steps were repeated on the other surface of the aluminum foil to obtain a positive electrode plate with positive electrode material layers applied on two surfaces. The plate was dried under vacuum at 120° C. for 1 h, then cold-pressed, cut, and slit to obtain a positive electrode plate with specifications of 74 mm×867 mm. A compaction density in the cold pressing process was 4.2 g/cm³.

### <Preparation of Negative Electrode Plate>

Artificial graphite as a negative electrode active material, sodium carboxymethyl cellulose (CMC—Na) as a negative electrode binder, and styrene-butadiene rubber (SBR) as a negative electrode binder were mixed in a weight ratio of 95:2:3; and deionized water was added as a solvent. These substances were stirred and mixed to uniformity to obtain a negative electrode slurry, where a solid content of the negative electrode slurry was 75 wt %. The negative electrode slurry was uniformly applied on one surface of a 12 μm-thick copper foil serving as a negative electrode current collector, and dried at 120° C. to obtain a negative electrode plate with a negative electrode material layer of 120 μm in thickness applied on one surface. The above steps were repeated on the other surface of the copper foil to obtain a negative electrode plate with negative electrode material layers applied on two surfaces. The plate was dried under vacuum at 120° C. for 1 h, then cold-pressed, cut, and slit to obtain a negative electrode plate with specifications of 78 mm×875 mm. A compaction density in the cold pressing process was 1.75 g/cm³.

### <Preparation of Electrolyte>

In an argon atmosphere glove box with a water content of less than 10 ppm, ethylene carbonate (EC), dimethyl carbonate (DMC), and methyl ethyl carbonate (EMC) were mixed in a weight ratio of 1:1:1 to obtain a base solvent; and a lithium salt lithium hexafluorophosphate (LiPF₆) was then added. These substances were mixed uniformly to obtain an electrolyte. Based on a mass of the electrolyte, a mass percentage of the lithium salt was 12.5%, and the balance was for the base solvent.

### <Preparation of Separator>

A polyethylene (PE) film with a thickness of 15 μm was used.

### <Preparation of Lithium-Ion Battery>

The prepared positive electrode plate, separator, negative electrode plate, and separator were stacked in sequence, with the separators placed in the middle between the positive electrode plate and the negative electrode plate for separation, and wound to obtain an electrode assembly. After the tabs were welded, the electrode assembly was placed in an aluminum-plastic film packaging bag and dried, and the electrolyte was injected, followed by vacuum sealing, standing, formation, degassing, and cutting processes to obtain a lithium-ion battery.

### Examples 1-2 to 1-5

Except that the average particle size of primary particles of the carbon black particles was made as shown in Table 1 by regulating the reaction time of the high-temperature pyrolysis reaction, the rest was the same as Example 1-1.

### Examples 1-6 to 1-9

Except that the mass percentages of element oxygen and element hydrogen were made as shown in Table 1 by regulating the contents of the element oxygen and element hydrogen in the synthesis gas introduced during the high-temperature pyrolysis reaction, the rest was the same as Example 1-3.

### Examples 1-10 and 1-11

Except that the diameter of the carbon nanotubes was made as shown in Table 1 by regulating the synthesis temperature of the carbon nanotubes, the rest was the same as Example 1-3.

### Example 1-12

Except that the particle size Dᵥ50 of the positive electrode active material was regulated to 5 μm and the relevant preparation parameters were adjusted according to Table 1, the rest was the same as Example 1-3.

### Example 1-13

Except that the particle size Dᵥ50 of the positive electrode active material was regulated to 24 μm, the rest was the same as Example 1-3.

### Example 1-14

Except that the particle size Dᵥ50 of the positive electrode active material was regulated to 35 μm, the rest was the same as Example 1-3.

### Examples 1-15 to 1-21

Except that the relevant preparation parameters were adjusted according to Table 1, the rest was the same as Example 1-3.

### Examples 2-1 to 2-8

Except that the relevant preparation parameters were adjusted according to Table 2, the rest was the same as Example 1-3.

### Comparative Examples 1-1 and 1-2

Except that the relevant preparation parameters were adjusted according to Table 1, the rest was the same as Example 1-1.

### Comparative Example 1-3

Except that in <preparation of positive electrode plate>, lithium cobalt oxide (LiCoO₂) as a positive electrode active material, graphene as a conductive agent, carbon nanotubes as a conductive agent, and polyvinylidene fluoride (PVDF) as an organic polymer were mixed in a weight ratio of 97.6:0.4:0.5:1.5, NMP was added as a solvent, and these substances were stirred and mixed to uniformity to obtain a positive electrode slurry, the rest was the same as Example 1-1.

### Comparative Example 1-4

Except that in <preparation of positive electrode plate>, lithium cobalt oxide (LiCoO₂) as a positive electrode active material, carbon nanotubes as a conductive agent, and polyvinylidene fluoride (PVDF) as an organic polymer were mixed in a weight ratio of 97.6:0.9:1.5, NMP was added as a solvent, and these substances were stirred and mixed to uniformity to obtain a positive electrode slurry, the rest was the same as Example 1-1.

### Comparative Examples 2-1 and 2-2

Except that the relevant preparation parameters were adjusted according to Table 2, the rest was the same as Example 1-3.

The preparation parameters and electrical performance parameters of the examples and comparative examples are shown in Tables 1 and 2.

TABLE 1

| | | | | | | | Particle | | | | | | | | |
|---|---|---|---|---|---|---|---|---|---|---|---|---|---|---|---|
| | | | | | | | size Dᵥ50 | | | | | | 1 s | | |
| | | | | | | | of | | | | | | DCR | | |
| | | | | | | | particles | Organic polymer | | | | | at | | |
| | Carbon black | | | | | | of positive | Molecular | | | | | 25° C. | | |
| | particles | | | | | | electrode | weight | | | | | 20% | | |
| | d1 | W_{O} | W_{H} | d2 | 200d1 | 5000d1 | material | distribution | | C | H | F | SOC | R1 | T |
| | (nm) | (%) | (%) | (nm) | (μm) | (μm) | layer (μm) | range | Mw | (%) | (nm) | (N/m) | (mΩ) | (%) | (%) |
| Example | 5 | 2.0 | 0.4 | 8 | 1 | 25 | 13 | 5 W-150 W | 80 W | 70 | 50 | 5 | 55 | 30 | 15 |
| 1-1 | | | | | | | | | | | | | | | |
| Example | 10 | 2.0 | 0.4 | 8 | 2 | 50 | 13 | 5 W-150 W | 80 W | 78 | 35 | 8 | 50 | 25 | 7 |
| 1-2 | | | | | | | | | | | | | | | |
| Example | 20 | 2.0 | 0.4 | 8 | 4 | 100 | 13 | 5 W-150 W | 80 W | 90 | 25 | 13 | 35 | 15 | 5 |
| 1-3 | | | | | | | | | | | | | | | |
| Example | 30 | 2.0 | 0.4 | 8 | 6 | 150 | 13 | 5 W-150 W | 80 W | 80 | 32 | 16 | 40 | 23 | 7 |
| 1-4 | | | | | | | | | | | | | | | |
| Example | 40 | 2.0 | 0.4 | 8 | 8 | 200 | 13 | 5 W-150 W | 80 W | 75 | 40 | 18 | 52 | 28 | 10 |
| 1-5 | | | | | | | | | | | | | | | |
| Example | 20 | 0.3 | 0.1 | 8 | 4 | 100 | 13 | 5 W-150 W | 80 W | 60 | 60 | 17 | 58 | 34 | 18 |
| 1-6 | | | | | | | | | | | | | | | |
| Example | 20 | 0.8 | 0.2 | 8 | 4 | 100 | 13 | 5 W-150 W | 80 W | 68 | 45 | 15 | 56 | 32 | 16 |
| 1-7 | | | | | | | | | | | | | | | |
| Example | 20 | 1.5 | 0.3 | 8 | 4 | 100 | 13 | 5 W-150 W | 80 W | 80 | 33 | 14 | 40 | 23 | 7 |
| 1-8 | | | | | | | | | | | | | | | |
| Example | 20 | 3.0 | 0.5 | 8 | 4 | 100 | 13 | 5 W-150 W | 80 W | 95 | 20 | 11 | 30 | 12 | 8 |
| 1-9 | | | | | | | | | | | | | | | |
| Example | 20 | 2.0 | 0.4 | 3 | 4 | 100 | 13 | 5 W-150 W | 80 W | 83 | 30 | 10 | 30 | 12 | 6 |
| 1-10 | | | | | | | | | | | | | | | |
| Example | 20 | 2.0 | 0.4 | 15 | 4 | 100 | 13 | 5 W-150 W | 80 W | 92 | 22 | 16 | 38 | 18 | 4 |
| 1-11 | | | | | | | | | | | | | | | |
| Example | 10 | 2.0 | 0.4 | 8 | 2 | 50 | 3 | 5 W-150 W | 80 W | 68 | 35 | 5 | 58 | 32 | 16 |
| 1-12 | | | | | | | | | | | | | | | |
| Example | 20 | 2.0 | 0.4 | 8 | 4 | 100 | 20 | 5 W-150 W | 80 W | 93 | 28 | 15 | 38 | 20 | 4 |
| 1-13 | | | | | | | | | | | | | | | |
| Example | 20 | 2.0 | 0.4 | 8 | 4 | 100 | 30 | 5 W-150 W | 80 W | 98 | 30 | 16 | 42 | 25 | 3 |
| 1-14 | | | | | | | | | | | | | | | |
| Example | 20 | 2.0 | 0.4 | 8 | 4 | 100 | 13 | 2 W-100 W | 60 W | 95 | 21 | 9 | 30 | 16 | 8 |
| 1-15 | | | | | | | | | | | | | | | |
| Example | 20 | 2.0 | 0.4 | 8 | 4 | 100 | 13 | 10 W-180 W | 100 W | 86 | 28 | 16 | 31 | 17 | 5 |
| 1-17 | | | | | | | | | | | | | | | |
| Example | 20 | 2.0 | 0.4 | 8 | 4 | 100 | 13 | 20 W-250 W | 120 W | 82 | 29 | 20 | 33 | 22 | 7 |
| 1-18 | | | | | | | | | | | | | | | |
| Example | 20 | 2.0 | 0.4 | 8 | 4 | 100 | 13 | 2 W-200 W | 80 W | 95 | 22 | 13 | 30 | 10 | 4 |
| 1-19 | | | | | | | | | | | | | | | |
| Example | 20 | 2.0 | 0.4 | 8 | 4 | 100 | 13 | 2 W-90 W | 30 W | 96 | 20 | 5 | 28 | 19 | 7 |
| 1-20 | | | | | | | | | | | | | | | |
| Example | 20 | 2.0 | 0.4 | 8 | 4 | 100 | 13 | 30 W-250 W | 150 W | 80 | 30 | 23 | 35 | 24 | 6 |
| 1-21 | | | | | | | | | | | | | | | |
| Comparative | 5 | 0.3 | 0.1 | 8 | 1 | 25 | 13 | 5 W-150 W | 80 W | 55 | 60 | 8 | 65 | 50 | 22 |
| Example 1-1 | | | | | | | | | | | | | | | |
| Comparative | 20 | 3.0 | 0.5 | 8 | 4 | 100 | 13 | 2 W-100 W | 60 W | 99 | 15 | 5 | 45 | 45 | 25 |
| Example 1-2 | | | | | | | | | | | | | | | |
| Comparative | / | 1 | / | 8 | / | 1 | 13 | 5 W-150 W | 80 W | / | / | 9 | 75 | 50 | 10 |
| Example 1-3 | | | | | | | | | | | | | | | |
| Comparative | / | / | / | 8 | / | / | 13 | 5 W-150 W | 80 W | / | / | 8 | 30 | 60 | 15 |
| Example 1-4 | | | | | | | | | | | | | | | |

Note:
(1) In Table 1, “/” indicates no relevant preparation parameter.
(2) In Table 1, taking Example 1-1 as an example, “organic polymer molecular weight distribution range” being “5 W-150 W” means that the organic polymer molecular weight distribution range is 50000 to 1500000, and other examples are analogous.

From Examples 1-1 to 1-21 and Comparative Examples 1-1 to 1-4, it can be seen that when the type of the conductive agent and the coverage rate of the carbon black particles on the positive electrode active material particles are within the ranges of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance. In Comparative Examples 1-1 and 1-2, the coverage rate of the carbon black particles on the positive electrode active material particles is not within the range of this application, and the prepared lithium-ion battery has higher is DCR at 25° C. 20% SOC, internal resistance growth rate after 800 cycles at 25° C., and high-temperature storage thickness swelling rate, indicating that the dynamic performance of the lithium-ion battery is poor, the internal resistance is high, and the high-temperature performance of the lithium-ion battery is poor. In Comparative Examples 1-3 and 1-4, the type of the conductive agent is not within the range of this application, and the prepared lithium-ion battery has higher is DCR at 25° C. 20% SOC, internal resistance growth rate after 800 cycles at 25° C., and high-temperature storage thickness swelling rate, indicating that the dynamic performance of the lithium-ion battery is poor, the internal resistance is high, and the high-temperature performance of the lithium-ion battery is poor.

The average particle size of primary particles of the carbon black particles usually affects the dynamic performance of the lithium-ion battery. From Examples 1-1 to 1-5, it can be seen that by regulating the average particle size of primary particles of the carbon black particles within the range of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and also good high-temperature performance.

The mass percentages of element oxygen and element hydrogen usually affect the dynamic performance of the lithium-ion battery. From Example 1-3 and Examples 1-6 to 1-9, it can be seen that by regulating the mass percentages of element oxygen and element hydrogen within the ranges of this application, the prepared lithium-ion battery has lower 1 s DCR at 25° C. 20% SOC, internal resistance growth rate after 800 cycles at 25° C., and high-temperature storage thickness swelling rate, indicating that the lithium-ion battery has good dynamic performance, low internal resistance, and also good high-temperature performance.

The diameter of the carbon nanotubes usually affects the internal resistance of the lithium-ion battery. From Example 1-3 and Examples 1-10 and 1-11, it can be seen that by regulating the diameter of the carbon nanotubes within the range of this application, the prepared lithium-ion battery has lower is DCR at 25° C. 20% SOC, internal resistance growth rate after 800 cycles at 25° C., and high-temperature storage thickness swelling rate, indicating that the internal resistance of the lithium-ion battery can be reduced, and the lithium-ion battery also has good dynamic performance and high-temperature performance. In Example 1-3 and Examples 1-10 and 1-11, the increase in the diameter of the carbon nanotubes is conducive to improving the dispersion of the carbon nanotubes and the carbon black particles, and the coverage rate of the carbon black particles on the positive electrode active material particles increases. In addition, the increase in the diameter of the carbon nanotubes reduces the specific surface area of the carbon nanotubes, reduces the amount of binder consumed, and increases the adhesion force between the positive electrode material layer and the positive electrode current collector.

The particle size Dᵥ50 of particles of the positive electrode material layer usually affects the dynamic performance and high-temperature performance of the lithium-ion battery. From Example 1-3 and Examples 1-12 to 1-14, it can be seen that by regulating the particle size Dᵥ50 of particles of the positive electrode material layer within the range of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance. In Example 1-12, the particle size Dᵥ50 of particles of the positive electrode material layer is small, the dispersion of particles of the positive electrode material layer is relatively poor, the coverage rate of the carbon black particles on the positive electrode active material particles is small, and the stacking thickness of the carbon black particles on the surface of the positive electrode active material particles is large. In Example 1-3, Example 1-13, and Example 1-14, the particle size Dᵥ50 of particles of the positive electrode material layer increases, the specific surface area of particles of the positive electrode material layer decreases, the mass percentage of the carbon black particles remains unchanged, the coverage rate of the carbon black particles on the positive electrode active material particles increases, and the stacking thickness of the carbon black particles on the surface of the positive electrode active material particles increases.

The molecular weight distribution range and weight-average molecular weight of the organic polymer usually affect the dynamic performance and cycling performance of the lithium-ion battery. From Example 1-3 and Examples 1-15 to 1-21, it can be seen that by regulating the molecular weight distribution range and weight-average molecular weight of the organic polymer within the ranges of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance.

TABLE 2

| | Mass percentage | | | | | Mass | | | | | | 1 s | | |
|---|---|---|---|---|---|---|---|---|---|---|---|---|---|---|
| | of substance in | | | | | ratio of | | Type of | | | | DCR at | | |
| | positive electrode | | | | | conductive | | positive | | | | 25° C. | | |
| | material layer | | | | | agent to | Type of | electrode | | | | 20% | | |
| | W21 | W22 | W2 | W3 | W1 | organic | organic | active | C | H | F | SOC | R1 | T |
| | (%) | (%) | (%) | (%) | (%) | polymer | polymer | material | (%) | (nm) | (N/m) | (mΩ) | (%) | (%) |
| Example | 0.4 | 0.5 | 0.9 | 1.50 | 97.6 | 0.6 | PVDF | LCO | 90 | 25 | 13 | 35 | 15 | 5 |
| 1-3 | | | | | | | | | | | | | | |
| Example | 0.3 | 0.2 | 0.5 | 0.50 | 99.0 | 1.0 | PVDF | LCO | 60 | 35 | 5 | 60 | 40 | 20 |
| 2-1 | | | | | | | | | | | | | | |
| Example | 0.8 | 0.5 | 1.3 | 1.50 | 97.2 | 0.9 | PVDF | LCO | 90 | 50 | 9 | 30 | 12 | 6 |
| 2-2 | | | | | | | | | | | | | | |
| Example | 1.2 | 0.2 | 1.4 | 1.80 | 96.8 | 0.8 | PVDF | LCO | 85 | 55 | 9 | 38 | 19 | 7 |
| 2-3 | | | | | | | | | | | | | | |
| Example | 1.5 | 0.5 | 2.0 | 3.00 | 95.0 | 0.7 | PVDF | LCC | 95 | 60 | 8 | 35 | 20 | 5 |
| 2-4 | | | | | | | | | | | | | | |
| Example | 0.3 | 0.8 | 1.1 | 1.50 | 97.4 | 0.7 | PVDF | LCC | 80 | 22 | 15 | 32 | 13 | 8 |
| 2-5 | | | | | | | | | | | | | | |
| Example | 0.4 | 0.5 | 0.9 | 1.50 | 97.6 | 0.6 | Polyacrylate | LCO | 85 | 28 | 15 | 38 | 13 | 10 |
| 2-6 | | | | | | | | | | | | | | |
| Example | 0.8 | 0.7 | 1.5 | 3.10 | 95.4 | 0.5 | PVDF | Lithium iron | 80 | 20 | 12 | 40 | 10 | 7 |
| 2-7 | | | | | | | | phosphate | | | | | | |
| Example | 0.6 | 0.8 | 1.4 | 2.60 | 96.0 | 0.5 | PVDF | NCM811 | 85 | 22 | 15 | 42 | 18 | 4 |
| 2-8 | | | | | | | | | | | | | | |
| Comparative | 2.0 | 0.5 | 2.5 | 3.00 | 94.5 | 0.8 | PVDF | LCO | 99 | 75 | 4 | 65 | 55 | 23 |
| Example | | | | | | | | | | | | | | |
| 2-1 | | | | | | | | | | | | | | |
| Comparative | 0.3 | 0.2 | 0.5 | 0.4 | 99.1 | 1.3 | PVDF | LCO | 55 | 38 | 4 | 68 | 45 | 25 |
| Example | | | | | | | | | | | | | | |
| 2-2 | | | | | | | | | | | | | | |

Note:
(1) In Table 2, taking Example 1-3 as an example, the type of positive electrode active material being “LCO” means that the positive electrode active material is lithium cobalt oxide (LiCoO₂), and other examples are analogous.

From Examples 2-1 to 2-8 and Comparative Examples 2-1 and 2-2, it can be seen that when the type of the conductive agent and the coverage rate of the carbon black particles on the positive electrode active material particles are within the ranges of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance. In Comparative Examples 2-1 and 2-2, the coverage rate of the carbon black particles on the positive electrode active material particles is not within the range of this application, and the prepared lithium-ion battery has higher is DCR at 25° C. 20% SOC, internal resistance growth rate after 800 cycles at 25° C., and high-temperature storage thickness swelling rate, indicating that the dynamic performance of the lithium-ion battery is poor, the internal resistance is high, and the high-temperature performance of the lithium-ion battery is poor.

The mass percentages of the positive electrode active material, the carbon black particles, the carbon nanotubes, and the organic polymer usually affect the dynamic performance, high-temperature performance, and internal resistance of the lithium-ion battery. From Example 1-3 and Examples 2-1 to 2-5, it can be seen that by regulating the mass percentages of the positive electrode active material, the carbon black particles, the carbon nanotubes, and the organic polymer within the ranges of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance.

The type of the organic polymer usually affects the dynamic performance and cycling performance of the lithium-ion battery. From Example 1-3 and Example 2-6, it can be seen that by regulating the type of the organic polymer within the range of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance.

The type of the positive electrode active material usually affects the dynamic performance, high-temperature performance, and internal resistance of the lithium-ion battery. From Example 1-3 and Examples 2-7 and 2-8, it can be seen that by regulating the type of the positive electrode active material within the range of this application, the prepared lithium-ion battery has lower is DCR at 25° C. 20% SOC, internal resistance growth rate after 800 cycles at 25° C., and high-temperature storage thickness swelling rate, indicating that the lithium-ion battery has good dynamic performance, low internal resistance, and good high-temperature performance.

It should be noted that in this document, relational terms such as first and second are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method or article including a series of elements not only includes those elements, but also includes other elements not explicitly listed, or also includes elements inherent to such process, method or article.

The various embodiments in this specification are described in a related manner, and the same and similar parts between the various embodiments can be referred to each other, and each embodiment focuses on the differences from other embodiments.

The above are only preferred embodiments of this application and are not intended to limit this application. Any modifications, equivalent replacements, improvements, and the like made within the spirit and principles of this application should be included in the protection scope of this application.

1. A secondary battery, comprising a positive electrode plate, wherein the positive electrode plate comprises a positive electrode current collector and a positive electrode material layer provided on at least one surface of the positive electrode current collector, the positive electrode material layer comprises a positive electrode active material and a conductive agent, the conductive agent comprises carbon black particles, and a coverage rate of the carbon black particles on positive electrode active material particles is C %, wherein 60≤C≤98.

2. The secondary battery according to claim 1, wherein 80≤C≤95.

3. The secondary battery according to claim 1, wherein a stacking thickness of the carbon black particles on the surface of the positive electrode active material particles is H nm, wherein 20≤H≤60.

4. The secondary battery according to claim 1, wherein an average particle size of primary particles of the carbon black particles is d1 nm, wherein 5≤d1≤40.

5. The secondary battery according to claim 4, wherein the average particle size of the primary particles of the carbon black particles is d1 nm, wherein 10≤d1≤30.

6. The secondary battery according to claim 4, wherein a particle size Dᵥ50 of particles of the positive electrode material layer satisfies: 200d1≤Dᵥ50≤5000d1.

7. The secondary battery according to claim 6, wherein 3 μm≤Dᵥ50≤30 μm.

8. The secondary battery according to claim 1, wherein the carbon black particles comprise element oxygen; and based on a mass of the carbon black particles, a mass percentage of the element oxygen is W_{O} %, wherein 0.3≤W_{O}≤3.

9. The secondary battery according to claim 1, wherein the carbon black particles comprise element hydrogen; and based on a mass of the carbon black particles, a mass percentage of the element hydrogen is W_{H} %, wherein 0.1≤W_{H}≤0.5.

10. The secondary battery according to claim 1, wherein the positive electrode material layer further comprises an organic polymer, and a molecular weight distribution range of the organic polymer is 20000 to 2500000.

11. The secondary battery according to claim 10, wherein a weight-average molecular weight of the organic polymer is Mw, wherein 300000≤Mw≤1500000.

12. The secondary battery according to claim 10, wherein a mass ratio of the conductive agent to the organic polymer is in a range of 0.5 to 1.0.

13. The secondary battery according to claim 10, wherein the organic polymer comprises one or more selected from the group consisting of polyvinylidene fluoride, polyvinylpyrrolidone, hydrogenated nitrile rubber, a copolymer of vinylidene fluoride-hexafluoropropylene, polyacrylonitrile, polyacrylate, polyacrylic acid, polyacrylate salt, polyamide, polyvinyl ether, polymethyl methacrylate, polytetrafluoroethylene, polyhexafluoropropylene, styrene-butadiene rubber, polypropylene, polyethylene, polyetherimide, a copolymer of olefin derivatives, and carboxymethyl cellulose salt.

14. The secondary battery according to claim 10, wherein based on a mass of the positive electrode material layer, a mass percentage of the positive electrode active material is W1%, a mass percentage of the conductive agent is W2%, and a mass percentage of the organic polymer is W3%, wherein 95.0≤W1≤99.0, 0.5≤W2≤2.0, and 0.5≤W3≤3.0.

15. The secondary battery according to claim 10, wherein the conductive agent further comprises carbon nanotubes, and a diameter of the carbon nanotubes is d2 nm, wherein 3≤d2≤15.

16. The secondary battery according to claim 15, wherein based on a mass of the positive electrode material layer, a mass percentage of the positive electrode active material is W1%, a mass percentage of the carbon black particles is W21%, a mass percentage of the carbon nanotubes is W22%, and a mass percentage of the organic polymer is W3%, wherein 95.0≤W1≤99.0, 0.3≤W21≤1.5, 0.2≤W22≤0.8, and 0.5≤W3≤3.0.

17. The secondary battery according to claim 1, wherein an adhesion force between the positive electrode material layer and the positive electrode current collector is F N/m, wherein 5≤F≤25.

18. The secondary battery according to claim 1, wherein the positive electrode active material comprises one or more selected from the group consisting of lithium cobalt oxide, lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, and lithium titanate.

19. An electronic device, comprising the secondary battery according to claim 1.
